(19) United States
(12) Patent Application Publication
(10) Pub. No.: US 2011/0054364 A1
(43) Pub. Date: Mar. 3, 2011

(54) EXERCISE SYSTEM

(76) Inventors: Masayuki Mitsui, Hikone-shi (JP); Matsuki Yamamoto, Ashiya-shi (JP); Yukiko Mishima, Takatsuki-shi (JP)

(21) Appl. No.: 12/988,367

(22) PCT Filed: Apr. 16, 2009
(86) PCT No.: PCT/JP2009/057647

§ 371 Date: Nov. 18, 2010

(30) Foreign Application Priority Data
Apr. 18, 2008 (JP) 2008-109433

(51) Int. Cl. A61H 1/00

(52) U.S. Cl. 601/5

(57) ABSTRACT

The exercise system includes a passive exercise device (10), an acceleration sensor (20), a posture evaluation device (30), and an indication device (40). The passive exercise device (10) is configured to allow a user (80) to perform a passive exercise. The acceleration sensor (20) is attached around the lower back of user (80), and is configured to measure accelerations respectively in three axial directions and output the measured accelerations to the posture evaluation device (30). The posture evaluation device (30) is configured to calculate, on the basis of the acceleration, a physical amount for evaluation of a posture of the user (80) performing the passive exercise, and make an evaluation of the posture of the user (80) by comparing the calculated physical amount with a predetermined reference value. The posture evaluation device (30) is configured to prepare, on the basis of the resultant evaluation, an exercise instruction for remediation of the posture of the user (80). The indication device (40) is configured to indicate the exercise instruction to the user (80).

### TECHNICAL FIELD

The present invention is directed to an exercise system employing a passive exercise device.

### BACKGROUND ART

Japanese patent laid-open publication No. 2007-21231 discloses a horse riding type passive exercise device. The passive exercise device includes a saddle-shaped seat designed to allow a user to sit astride it. The passive exercise device reciprocates the seat to allow the user sitting astride the seat to perform a passive exercise simulating horse riding motion.

A user (expert) who is skilled in the use of the passive exercise device can move one's body to follow motion of the seat. Therefore, the expert can train targeted muscles, and can remove excess fat.

In contrast, a user (beginner) who is inexperienced in the use of the passive exercise device fails to move one's body to follow the motion of the seat. Therefore, beginner can not get a sufficient exercise effect.

For example, when using the horse riding type passive exercise device, a user is required to keep one's upper body balanced in a way not to shake one's head during the reciprocation of the seat. The expert is likely to show less movement of one's head while moving one's lower back greatly in response to the movement of the seat. In contrast, the beginner is difficult to move one's lower back in a direction of absorbing the movement of the seat, and is likely to suffer from the exaggerated movement of one's head and upper body.

Consequently, it is preferable for the beginner that an exercise instructor observes one's posture at the passive exercise and corrects one's wrong move. However, the user at home is difficult to be checked by an instructor regarding one's posture during the passive exercise. In view of the above, the beginner can check one's posture at the passive exercise in a mirror. However, it is difficult for the beginner to judge, on the basis of one's posture during the passive exercise, which part of one's body shows a poor movement, and which point is considered in order to remedy one's posture.

### DISCLOSURE OF INVENTION

In view of the above insufficiency, the present invention has been aimed to propose an exercise system capable of indicating to a user an exercise instruction for remediation of a posture of the user performing a passive exercise.

The exercise system in accordance with the present invention includes a passive exercise device, an acceleration sensor, a posture evaluation device, and an indication device. The passive exercise device includes a seat where a user sits. The passive exercise device is configured to move the seat to allow the user to perform a passive exercise. The acceleration sensor is adapted to be attached around the user's lower back. The acceleration sensor is configured to measure accelerations respectively in three axial directions and output the measured accelerations to the posture evaluation device. The posture evaluation device includes a physical amount calculation unit and an exercise instruction preparing unit. The physical amount calculation unit is configured to calculate, on the basis of the acceleration output from the acceleration sensor, a physical amount for evaluation of a posture of the user performing the passive exercise. The exercise instruction preparing unit is configured to make an evaluation of the user's posture by comparing the physical amount calculated by the physical amount calculation unit with a predetermined reference value. The exercise instruction preparing unit is configured to prepare, on the basis of the resultant evaluation, an exercise instruction for remediation of the user's posture. The indication device is configured to indicate the exercise instruction prepared by the exercise instruction preparing unit to the user.

The aforementioned exercise system in accordance with the present invention can indicate the exercise instruction for remediation of the posture at the passive exercise to the user. Therefore, the user can remedy own posture at the passive exercise in accordance with the indicated exercise instruction. As a result, the user can perform an effective training even if an exercise instructor is absent.

In a preferred embodiment, the posture evaluation device includes an exercise instruction storage unit configured to store the exercise instructions. The exercise instruction preparing unit is configured to read out the exercise instruction corresponding to the resultant evaluation of the user's posture from the exercise instruction storage unit, thereby preparing the exercise instruction.

In the preferred embodiment, the exercise system can easily prepare the exercise instruction.

In a preferred embodiment, the passive exercise device is configured to reciprocate the seat along a forward/rearward direction within a plane perpendicular to a lateral direction. The physical amount is defined as a variation of an angle of the user's pelvis relative to a vertical direction.

In the preferred embodiment, the exercise system can evaluate whether or not the user can keep the pelvis in a proper position with an aid of one's abdominal or back muscles.

In a preferred embodiment, the passive exercise device is configured to reciprocate the seat along a forward/rearward direction within a plane perpendicular to a lateral direction. The physical amount is defined as a forward/rearward displacement of the user's body.

In the preferred embodiment, the exercise system can evaluate whether or not the user can absorb the movement of the seat in the forward/rearward direction by the effect of varying the angle of the pelvis. The exercise system can also evaluate whether or not the user can support the pelvis by tensing one's abdominal muscles. Further, the exercise system can evaluate whether or not the user's upper body does not move in the forward/rearward direction.

In a preferred embodiment, the passive exercise device is configured to reciprocate the seat along a lateral direction within a plane perpendicular to a forward/rearward direction. The physical amount is defined as a lateral displacement of the user's body.

In the preferred embodiment, the exercise system can evaluate whether or not the user supports one's own lower back by holding the seat between one's tensed thighs. The exercise system can evaluate whether or not the user's upper body does not move in the lateral direction.

In a preferred embodiment, the passive exercise device is configured to reciprocate the seat in a bilaterally symmetrical manner. The physical amount is defined as a difference between a movement of the user's body obtained while the seat is inclined leftward and a movement of the user's body obtained while the seat is inclined rightward.

In the preferred embodiment, the exercise system can evaluate whether or not the user is making laterally balanced exercise.

In a preferred embodiment, the passive exercise device is configured to move the seat periodically. The physical amount calculation unit is configured to calculate a plurality of the physical amounts. One of the plurality of the physical amounts is defined as a dispersion of another physical amount per unit period.

In the preferred embodiment, the exercise system can evaluate whether or not the user is making the passive exercise in a stably manner.

In a preferred embodiment, the passive exercise device is configured to move the seat periodically. The physical amount is defined as a dispersion of a value per unit period, and the value being calculated by use of the acceleration obtained from the acceleration sensor.

In the preferred embodiment, the exercise system can evaluate whether or not the user is making the passive exercise in a stably manner.

### BRIEF DESCRIPTION OF DRAWINGS

FIG. 1 is a block diagram illustrating an exercise system of one embodiment in accordance with the present invention,

FIG. 2 is a schematic view illustrating the above exercise system,

FIG. 3 is a block diagram illustrating a passive exercise device of the above exercise system,

FIG. 4A is a diagram viewed from above illustrating the passive exercise device on which a user is riding,

FIG. 4B is a diagram viewed from above illustrating a trace of a lower back of the user performing a passive exercise,

FIG. 4C is a diagram viewed from side illustrating the passive exercise device on which the user is riding,

FIG. 5A is an explanatory view illustrating a method of calculating a pelvis angle,

FIG. 5B is an explanatory view illustrating the method of calculating the pelvis angle,

FIG. 6 shows a graph (a) illustrating a lateral displacement with time, and a graph (b) illustrating acceleration in the lateral direction with time;

FIG. 7 shows a graph (a) illustrating an observed acceleration measurement in the lateral direction with time, and a graph (b) illustrating an observed acceleration measurement in a forward/rearward direction with time;

FIG. 8 is a flowchart illustrating an operation of the above exercise system,

FIG. 9 is an explanatory view illustrating a screen displaying a diagnosis,

FIG. 10A is a graph illustrating a variation of the pelvis angle obtained during the passive exercise,

FIG. 10B is a graph illustrating a variation of the pelvis angle obtained during the passive exercise,

FIG. 11A is a diagram viewed from above illustrating a trace of the lower back of the user performing the passive exercise,

FIG. 11B is a diagram viewed from above illustrating a trace of the lower back of the user performing the passive exercise,

FIG. 11C is a diagram viewed from above illustrating a trace of the lower back of the user performing the passive exercise,

FIG. 11D is a diagram viewed from above illustrating a trace of the lower back of the user performing the passive exercise, and

FIG. 11E is a diagram viewed from above illustrating a trace of the lower back of the user performing the passive exercise.

### BEST MODE FOR CARRYING OUT THE INVENTION

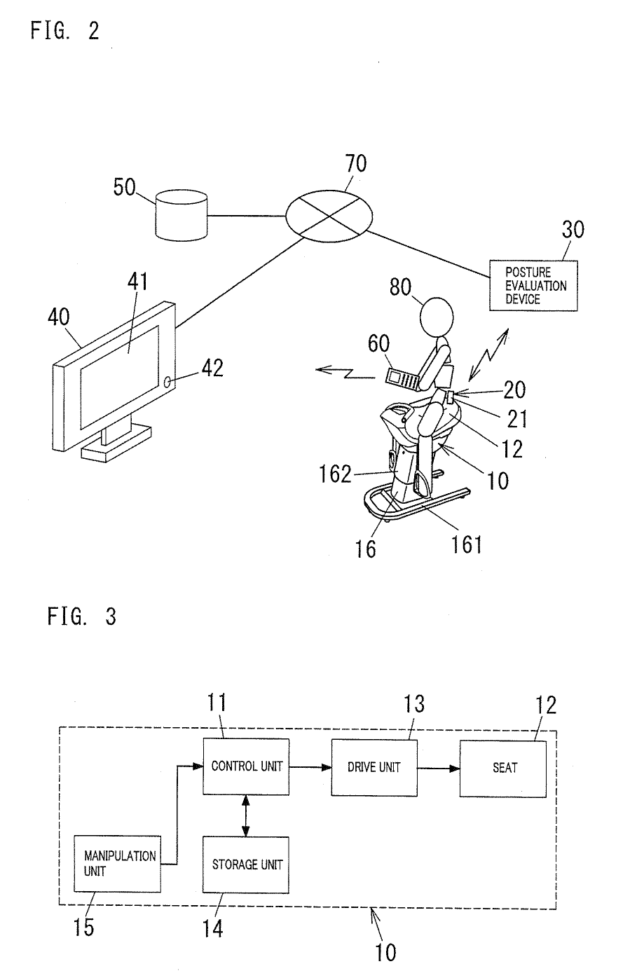

As shown in FIG. 2, the exercise system of one embodiment in accordance with the present invention includes, a passive exercise device 10, an acceleration sensor 20, a posture evaluation device 30, an image display device (indication device) 40, and a server (web server) 50. The posture evaluation device 30, the image display device 40, and the server 50 are connected with each other via a communication network (internet) 70. The posture evaluation device 30, the image display device 40, and the server 50 are configured to establish a data communication with each other via the communication network (internet) 70.

The server 50 is configured to deliver various contents (e.g. information contents, and image contents) to the image display device 40. The server 50 includes, as one of the contents, an application (web application) 51 for diagnosing the posture of a user 80 performing a passive exercise with the passive exercise device 10. The server 50 is configured to execute the application 51 in response to a request from the image display device 40.

The passive exercise device 10 is configured to allow the user 80 to perform the passive exercise. The passive exercise is defined as an exercise applying external forces to a user's body, thereby stretching the user's muscles. Through making the passive exercise by use of he passive exercise device 10, the user 80 can get the approximately same exercise effect as the user 80 endeavor to exercise one's muscle voluntarily.

As shown in FIGS. 2 to 4, the passive exercise device 10 includes a control unit 11, a seat 12, a drive unit 13, a storage unit 14, a manipulation unit 15, and a main unit 16.

The seat 12 is shaped into a saddle shape allowing the user 80 to sit astride. The manipulation unit 15 is installed on an upper surface of a front end side of the seat 12.

In the passive exercise device 10, a reference position of the seat 12 is defined as a position of the seat 12 in which a direction of a pelvis of the user 80 sitting on the seat 12 is equivalent to that of the user 80 having a standing posture. In a condition the user 80 sits on the seat 12 placed in the reference position, a front/rearward direction, a lateral direction, and a vertical direction of the seat 12 are approximately identical to a front/rearward direction, a lateral direction, and a vertical direction of the user 80, respectively.

The main unit 16 includes a pedestal 161 to be placed in a certain position of a floor or the like, and a cylindrical portion 162 attached to an upper surface of the pedestal 161. The seat 12 is attached to an upper end of the cylindrical portion 162. The cylindrical portion 162 is configured to incorporate the control unit 11, the drive unit 13, and the storage unit 14.

The drive unit 13 is configured to reciprocate the seat 12. Especially, the drive unit 13 of the present embodiment is configured to reciprocate the seat 12 along the front/rearward direction within a plane perpendicular to the lateral direction (in other words, the drive unit 13 is configured to rotate the seat 12 normally and reversely around a rotation axis extending along the lateral direction). Additionally, the drive unit 13 is configured to reciprocate the seat 12 along the lateral direction within a plane perpendicular to the forward/rearward direction (in other words, the drive unit 13 is configured to rotate the seat 12 normally and reversely around a rotation axis extending along the forward/rearward direction).

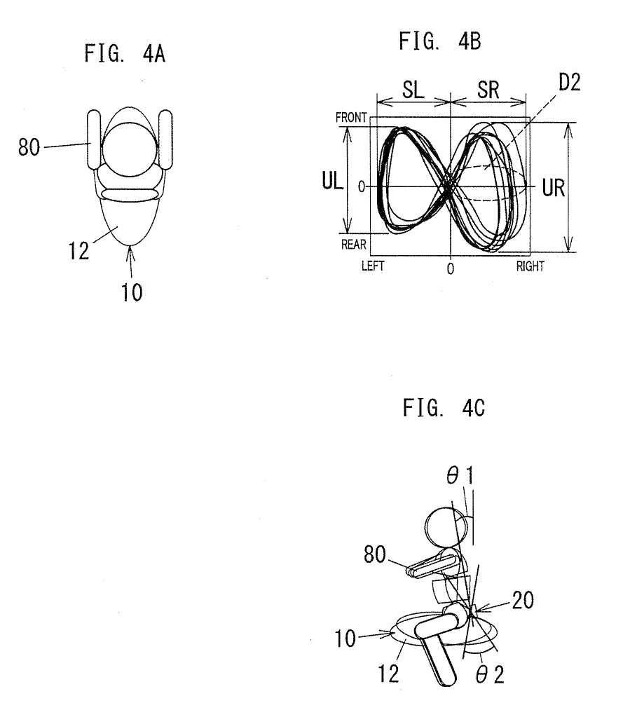

The storage unit 14 is configured to store operation programs allowing the drive unit 13 to reciprocate the seat 12 in various patterns. Especially, the storage unit 14 stores the operation program (hereinafter referred to as “basic program”) used for reciprocating the seat 12 periodically and bilaterally in such a way that the center of the seat 12 traces a figure “8” (see FIG. 4(b)). The basic program defines one cycle in which the seat 12 starts moving from the reference position and returning thereto while completing to trace the figure “8” by the center of the seat 12.

The manipulation unit 15 is configured to be used for the user 80 to make various manipulations (e.g. a manipulation of activating or deactivating, a manipulation of selecting the operation program, a manipulation of selecting a speed of reciprocation of the seat 12, and a manipulation of selecting an exercise time).

The control unit 11 is constructed by use of a micro computer. The control unit 11 is configured to control an operation of the drive unit 13 in response to a manipulation of the manipulation unit 15.

The passive exercise device 10 of the present embodiment is a horse riding type passive exercise device configured to reciprocate the seat 12 in order to allow the user 80 to perform a passive exercise which simulates a horse riding exercise. The exercise system can employ a passive exercise device allowing the user 80 to perform a walking exercise instead of the horse riding type passive exercise device 10.

The acceleration sensor 20 includes a housing 21 designed to be attached around the user's lower back by use of belt (not shown).

The housing 21 is shaped into a box shape, and is configured to house circuit components of the acceleration sensor 20. For example, the circuit components of the acceleration senor 20 includes an arithmetic processing unit 22, an acceleration detection unit 23, a storing unit 24, a wireless communication unit (signal output unit) 25, a manipulating unit 26, and a power unit 27.

The acceleration detection unit 23 is configured to measure a triaxial acceleration A (an acceleration Ax in an X-axis, an acceleration Ay in a Y-axis, and an acceleration Az in a Z-axis). The X-axis, the Y-axis, and the Z-axis are orthogonal to each other. The acceleration A measured by the acceleration detection unit 23 is output to the arithmetic processing unit 22.

The storing unit 24 is a storage device such as ROM and RAM. The storing unit 24 is configured to store an operation program of the arithmetic processing unit 22, and acceleration A.

The wireless communication unit 25 is configured to establish a short-range wireless communication with the posture evaluation device 30 by means of a predetermined communication method (e.g. Bluetooth [registered trademark], and IrDA [registered trademark]).

The manipulating unit 26 is configured to be used for the user 80 to make various manipulations (e.g. a manipulation of activating or deactivating, a manipulation of starting measurement and terminating measurement, a manipulation of setting various configurations).

The power unit 27 is configured to energize internal circuits (the arithmetic processing unit 22, the acceleration detection unit 23, the storing unit 24, the wireless communication unit 25, and the manipulating unit 26) by use of a battery.

The arithmetic processing unit 22 is a micro computer, for example. The arithmetic processing unit 22 is configured to control the above internal circuits. The arithmetic processing unit 22 retrieves the acceleration A from the acceleration detection unit 23 at a predetermined frequency and stores the retrieved acceleration A in the storing unit 24. When an acceleration request signal from the posture evaluation device 30 is received at the wireless communication unit 25, the arithmetic processing unit 22 retrieves the acceleration A over a predetermined measurement time. Thereafter, the arithmetic processing unit 22 controls the wireless communication unit 25 to transmit the retrieved acceleration A.

The acceleration sensor 20 is attached around the lower back of the user 80 such that the X-axis, Y-axis, and Z-axis of the acceleration detection unit 23 are respectively aligned with the lateral direction, forward/rearward direction, and vertical direction of the user 80 having the standing posture. Therefore, when the user 80 has the standing posture, the acceleration Ax in the X-axis denotes an acceleration in the lateral direction, and the acceleration Ay in the Y-axis denotes an acceleration in the forward/rearward direction, and the acceleration Az in the Z-axis denotes an acceleration in the vertical direction.

As apparent from the above, the acceleration sensor 20 is configured to measure the triaxial acceleration A (accelerations Ax, Ay, and Az respectively in three axial directions) and output the measured acceleration A to the posture evaluation device 30.

Besides, in the present embodiment, the acceleration sensor 20 transmits without modification the acceleration A measured by the acceleration detection unit 23 to the posture evaluation device 30. However, the acceleration sensor 20 may be configured to perform a below-mentioned zero point correction processing prior to transmission of the acceleration A to the posture evaluation device 30. The posture evaluation device 30 can reduce an amount of load when the zero point correction is made on the side of the acceleration sensor 20.

The posture evaluation device 30 is a computer (personal computer), and is configured to perform a posture diagnosis processing and the zero point correction processing (standing posture measurement processing). The posture diagnosis processing is defined to prepare an exercise instruction for remediation of the posture of the user 80 performing the passive exercise with the passive exercise device 10. The zero point correction processing is defined to correct an inclination of the acceleration sensor 20.

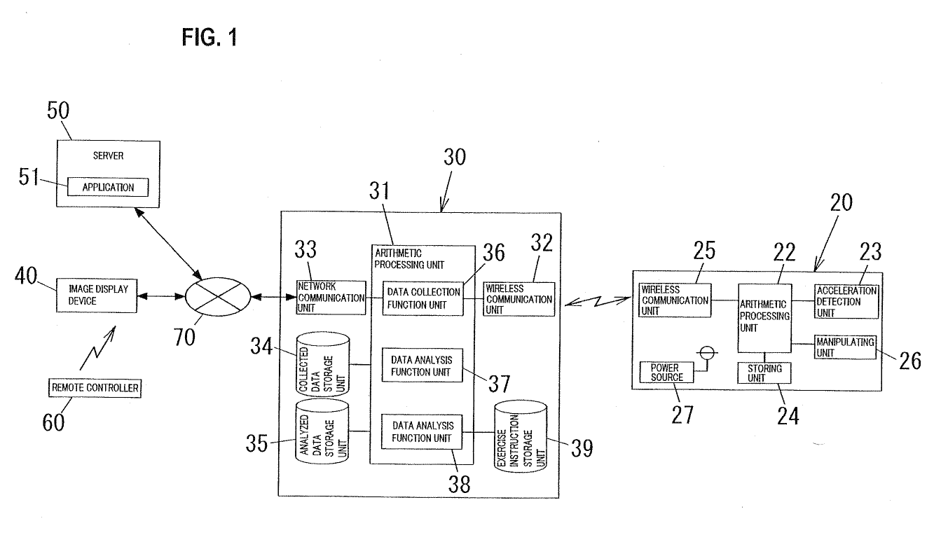

As shown in FIG. 1, the posture evaluation device 30 includes an arithmetic processing unit 31, a wireless communication unit 32, a network communication unit 33, a collected data storage unit 34, an analyzed data storage unit 35, and an exercise instruction storage unit 39. Besides, the collected data storage unit 34, the analyzed data storage unit 35, and the exercise instruction storage unit 39 are constructed by use of a storage device such as ROM and RAM.

The wireless communication unit 32 is configured to establish a short-range wireless communication with the acceleration sensor 20 by means of the aforementioned predetermined communication method. Therefore, the wireless communication unit 32 receives the acceleration A from the acceleration sensor 20.

The network communication unit 33 is configured to establish a data communication with the server 50 through the communication network 70.

The collected data storage unit 34 is configured to store the acceleration A received at the wireless communication unit 32.

The analyzed data storage unit 35 is configured to store results of various data analyses performed by the arithmetic processing unit 31 by use of the acceleration A.

The arithmetic processing unit 31 is a micro computer, for example. The arithmetic processing unit 31 includes a data collection function unit 36, a data analysis function unit 37, and an exercise instruction preparing unit 38. The data collection function unit 36, the data analysis function unit 37, and the exercise instruction preparing unit 38 are implemented by an arithmetic processing of the arithmetic processing unit 31.

The data collection function unit 36 is configured to control the wireless communication unit 32 to transmit the acceleration request signal in order to obtain the acceleration A from the acceleration sensor 20. The data collection function unit 36 is configured to store the acceleration A received at the wireless communication unit 32 in the collected data storage unit 34. The wireless communication unit 32 and the data collection function unit 36 constitute a sensor output obtainment unit configured to obtain the acceleration A defined as a sensor output of the acceleration sensor 20.

The data analysis function unit 37 is configured to calculate diagnostic indexes on the basis of the acceleration A measured by the acceleration sensor 20. The diagnostic index is defined as a physical amount for evaluating (diagnosing) the posture of the user 80 performing the passive exercise. The data analysis function unit 37 reads out the acceleration A from the collected data storage unit 34 in order to calculate the diagnostic index. The data analysis function unit 37 stores the calculated diagnostic index in the analyzed data storage unit 35.

When using the horse riding type passive exercise device 10, an exercise instructor diagnoses the posture of the user 80 during the passive exercise with regard to the eight diagnostic points (a) to (h) indicated in a left column of Table 1 below. The exercise instructor judges, on the basis of diagnoses of the respective diagnostic points (a) to (h), whether or not the user 80 can ride properly on the passive exercise device 10.

TABLE 1

| diagnostic point | diagnostic index |
|---|---|
| (a) whether or not a user keeps one's | forward/rearward displacement of lower back, |
| upper body stable (back-and-forth, | lateral displacement of lower back |
| laterally). | |
| (b) whether or not a user is relaxing not | amplitude of pelvis angle |
| to tense muscles of one's body. | forward/rearward displacement of lower back |
| (c) whether or not a user is stabilizing | forward/rearward displacement of lower back |
| one's pelvis by tightening one's | |
| abdominal muscles. | |
| (d) whether or not a user is holding the | forward/rearward displacement of lower back, |
| seat between one's thighs tensed. | lateral displacement of lower back |
| (e) whether or not a user keeps one's | pelvis angle |
| pelvis at a proper position by working | |
| one's abdominal or back muscles. | |
| (f) whether or not a user is varying ones | amplitude of pelvis angle, forward/rearward |
| pelvis angle to absorb a movement of the | displacement of lower back |
| seat. | |
| (g) whether or not a user is riding in a | bilateral difference of forward/rearward |
| bilaterally symmetrical manner. | displacement of lower back |
| | bilateral difference of lateral displacement of |
| | lower back |
| (h) whether or not a user is riding stably. | dispersion of individual diagnostic index per |
| | unit period |

In view of the above, the posture evaluation device 30 is configured to make a similar diagnosis to the exercise instructor. That is, the posture evaluation device 30 is configured to diagnose the posture of the user 80 during the passive exercise with regard to the eight diagnostic points (a) to (h).

A right column of Table 1 indicates the diagnostic indexes corresponding to the respective diagnostic points (a) to (h). As apparent from Table 1, diagnosis of all the eight diagnostic points (a) to (h) requires the seven diagnostic indexes, that is, a “forward/rearward displacement of the lower back (forward/rearward swing)”, a “lateral displacement of the lower back (lateral swing)”, an “amplitude of the pelvis angle”, “pelvis angle”, a “bilateral deference of the forward/rearward displacement of the lower back”, a “bilateral deference of the lateral displacement of the lower back”, and a “dispersions of respective diagnostic indexes per unit period (stability degree)”.

Both the “bilateral deference of the forward/rearward displacement of the lower back” and the “bilateral deference of the lateral displacement of the lower back” relate to only the diagnostic point (g). Therefore, both the “bilateral deference of the forward/rearward displacement of the lower back” and the “bilateral deference of the lateral displacement of the lower back” are defined as a single diagnostic index referred to as a “bilateral difference of individual diagnostic index (right-and-left balance)”

The “amplitude of the pelvis angle” is corresponding to the diagnostic points (b) and (f) and the “forward/rearward displacement of the lower back” is also corresponding to the diagnostic points (b) and (f). A result obtained by diagnosing the diagnostic points (b) and (f) by use of only the “forward/rearward displacement of the lower back” is the approximately same as a result obtained by diagnosing the diagnostic points (b) and (f) by use of both the “amplitude of the pelvis angle” and the “forward/rearward displacement of the lower back”.

In view of the above, the posture evaluation device 30 of the present embodiment is configured to diagnose the posture of the user 80 by use of the five diagnostic indexes, that is, the “forward/rearward swing”, the “lateral swing”, the “pelvis angle”, the “right-and-left balance”, and the “stability degree”.

Next, an explanation is made to the respective diagnostic indexes with reference to FIG. 4. FIG. 4B is a diagram (hereinafter referred to as “exercise trace”) viewed from above illustrating a trace (trace of the acceleration sensor 20 attached to the user 80) of the lower back (pelvis) of the user 80.

The “forward/rearward swing” is defined by a displacement UR of the lower back of the user 80 along the forward/rearward direction in a right side area and a displacement UL of the lower back of the user 80 along the forward/rearward direction in a left side area. For example, the “forward/rearward displacement of the pelvis” is a greater one of the displacement UR and the displacement UL. The “forward/rearward displacement of the pelvis” may be an average of the displacement UR and the displacement UL.

The aforementioned right side area is defined as an area of a right side relative to a center position of the body of the user 80 sitting on the seat 12 positioned in the reference position. In other words, the right side area is defined as an area in which the seat 12 is inclined rightward relative to the reference position. The aforementioned left side area is defined as an area of a left side relative to the center position of the body of the user 80 sitting on the seat 12 positioned in the reference position. In other words, the left side area is defined as an area in which the seat 12 is inclined leftward relative to the reference position.

The “lateral swing” is defined by a displacement SR of the lower back of the user 80 along the lateral direction in the right side area and a displacement SL of the lower back of the user 80 along the lateral direction in the left side area. For example, the “lateral displacement of the pelvis” is a sum of SR and SL.

The “right-and-left balance” is the “bilateral deference of the forward/rearward displacement of the lower back” and the “bilateral deference of the lateral displacement of the lower back”. The “bilateral deference of the forward/rearward displacement of the lower back” is defined as a proportion UL/UR of the displacement UL to the displacement UR. The “bilateral deference of the lateral displacement of the lower back” is defined as a proportion SL/SR of the displacement SL to the displacement SR. Besides, the “bilateral deference of the forward/rearward displacement of the lower back” may be defined as an absolute value (=|UL−UR|) of a difference between UL and UR. The “bilateral deference of the lateral displacement of the lower back” may be defined as an absolute value (=|SL−SR|) of a difference between SL and SR.

The “stability degree” is a “dispersion of the lateral displacement of the pelvis per unit period”, for example. The “dispersion of the lateral displacement of the pelvis per unit period” is a dispersion of SL or SR (e.g. a standard deviation of SL or SR) (see D2 of FIG. 4B). Besides, the “stability degree” of the present embodiment need not be the dispersion of the diagnostic index per unit period, but may be a dispersion of a value calculated from the acceleration A per unit period. For example, the value calculated from the acceleration A is a value with the exception of the diagnostic index, or the above diagnostic index (e.g. the “amplitude of the pelvis angle”) not to be used for diagnosis in the present embodiment.

As shown in FIG. 4C, the “pelvis angle” is defined as an angle θ1 of the pelvis relative to the vertical direction within a plane perpendicular to the lateral direction. In the present embodiment, the direction of the pelvis of the user 80 having the standing posture is used as a reference.

As shown in FIG. 4C, the “amplitude of the pelvis angle” is defined as a width θ2 in which the pelvis angle θ1 is varied during the one period of the passive exercise.

Table 2 below shows relations as to which respective diagnostic indexes correspond to which ones of the respective diagnostic points.

As shown in Table 2, the “forward/rearward swing” is corresponding to the five diagnostic points (a) to (d), and (f). In order to hold the pelvis by strengthening abdominal muscles as shown in the diagnostic point (c), the user has to adjust the pelvis angle for absorbing a movement of the seat as shown in the diagnostic point (f). When the user can not fulfills the contents of the diagnostic points (c) and (f), the user's body becomes tense (the diagnostic point (b)), and the user's upper body will fluctuate (the diagnostic point (a). Therefore, the five diagnostic points (a) to (d), and (f) respectively corresponding to the “forward/rearward swing” relate with each other.

TABLE 2

| diagnostic index | diagnostic point |
|---|---|
| forward/rearward displacement of lower back | (a) whether or not a user keeps one's |
| | upper body stable (back-and-forth, |
| | laterally). |
| | (b) whether or not a user is relaxing not to |
| | tense muscles of one's body. |
| | (c) whether or not a user is stabilizing |
| | one's pelvis by tightening one's abdominal |
| | muscles. |
| | (d) whether or not a user is holding the |
| | seat between one's thighs tensed. |
| | (f) whether or not a user is varying ones |
| | pelvis angle to absorb a movement of the |
| | seat. |
| lateral displacement of lower back | (a) whether or not a user keeps one's |
| | upper body stable (back-and-forth, |
| | laterally). |
| | (d) whether or not a user is holding the |
| | seat between one's thighs tensed. |
| amplitude of pelvis angle | (b) whether or not a user is relaxing not to |
| | tense muscles of one's body. |
| | (f) whether or not a user is varying ones |
| | pelvis angle to absorb a movement of the |
| | seat. |
| pelvis angle | (e) whether or not a user keeps one's |
| | pelvis at a proper position by working |
| | one's abdominal or back muscles. |
| bilateral difference of individual diagnostic | (g) whether or not a user is riding in a |
| index | bilaterally symmetrical manner. |
| dispersion of individual diagnostic index per | (h) whether or not a user is riding stably |
| unit period | |

The data analysis function unit 37 calculates the above five diagnostic indexes on the basis of the acceleration A measured by the acceleration sensor 20. In the present embodiment, the data analysis function unit 37 acts as a physical amount calculation unit configured to calculate, on the basis of the acceleration A output from the acceleration sensor 20, the physical amount (diagnostic index) for evaluation of the posture of the user 80 during the passive exercise.

As mentioned in the above, the acceleration sensor 20 is preferred to be attached around the lower back of the user 80 such that the X-axis, Y-axis, and Z-axis of the acceleration detection unit 23 are respectively aligned with the lateral direction, forward/rearward direction, and vertical direction of the user 80 having the standing posture.

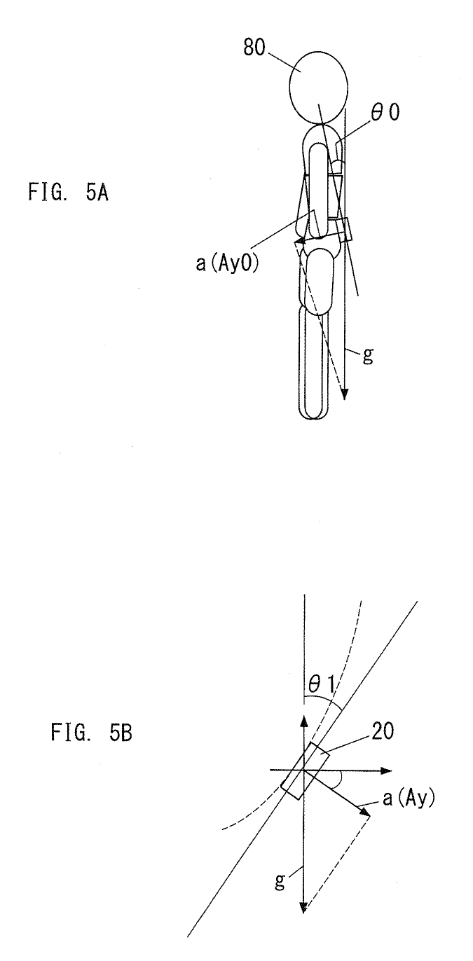

However, the attachment of the acceleration sensor 20 is performed by the user 80 by oneself. Therefore, actually, as shown in FIG. 5A, the Y-axis is likely to be deviated from the forward/rearward direction. When the Y-axis is deviated from the forward/rearward direction, an offset angle θ0 resulting from such deviation is added to the pelvis angle θ1. Therefore, the pelvis angle θ1 is likely not to be properly detected.

In view of the above, the posture evaluation device 30 is configured to perform the zero point correction processing as a preceding processing of the posture diagnosing process. When the zero point correction processing is performed, the user 80 should take the standing posture with attaching the acceleration sensor 20 to one's lower back.

In the zero point correcting process, the posture evaluation device 30 requests the acceleration sensor 20 to transmit the acceleration A thereto. In this situation, in response to the request of the posture evaluation device 30, the acceleration sensor 20 measures the acceleration A over the predetermined measurement time (e.g. 10 seconds) and transmits the measured acceleration A to the posture evaluation device 30.

When the wireless communication unit 32 receives the acceleration A, the data collection function unit 36 stores the acceleration A received at the wireless communication unit 32 in the collected data storage unit 34. The data analysis function unit 37 calculates the offset angle θ0 from the acceleration A stored in the collected data storage unit 34.

The offset angle θ0 is represented by the following formula (1), wherein a(Ay0) denotes an average (average during the predetermined measurement time) of the acceleration Ay in the Y-axis, and g denotes a gravity acceleration. Besides, the acceleration sensor 20 outputs a component of the gravity acceleration in a reversed sign due to its structural characteristics. Therefore, in the formula (1), a(Ay0) is multiplied by −1.

$$\begin{matrix}[ Formula 1 ] & \\ θ 0 = {sin}^{- 1} \frac{- a ( Ay 0 )}{g} & ( 1 )\end{matrix}$$

Next, an explanation is made to calculation methods of the above five diagnostic indexes.

First, an explanation is made to the calculation method of the pelvis angle θ1. The data analysis function unit 37 calculates the pelvis angle θ1 by use of an average (periodic average) a(Ay) of an acceleration Ay in the Y-axis corresponding to the forward/rearward direction during one period, and the gravity acceleration g. FIG. 5B shows an explanatory view illustrating the calculation method of the pelvis angle θ1.

The acceleration Ay is a sum of a Y-axial component of an acceleration (hereinafter referred to as “exercise acceleration”) resulting from the passive exercise of the user 80 and a Y-axial component of the gravity acceleration. When the passive exercise device 10 moves periodically the seat 12, a periodic average of the exercise acceleration is 0.

Therefore, the periodic average a(Ay) of the acceleration Ay is assumed to be equivalent to the Y-axial component of the gravity acceleration. Consequently, the pelvis angle θ1 is represented by the following formula (2).

$$\begin{matrix}[ Formula 2 ] & \\ θ 1 = {sin}^{- 1} \frac{a ( Ay )}{g} & ( 2 )\end{matrix}$$

Next, an explanation is made to the calculation methods of each of the forward/rearward swing and the lateral swing.

The displacement is calculated by double integration of the acceleration. Therefore, theoretically, the forward/rearward swing can be obtained by double integration of the acceleration Ay corresponding to the forward/rearward direction. Moreover, the lateral swing can be obtained by double integration of the acceleration Ax corresponding to the lateral direction.

However, a calculation showed that the trace of the lower back of the user 80 obtained by use of double integration of the acceleration was different from the actual trace of the lower back of the user 80. Therefore, it is difficult to accurately calculate the forward/rearward swing and the lateral swing by means of double integration of the acceleration.

The study of the present inventors showed that amplitude of the acceleration A measured by the acceleration sensor 20 has a correlation with amplitude (that is, the forward/rearward swing and the lateral swing) of the displacement.

Therefore, the data analysis function unit 37 is configured to calculate the displacements SL and SR by use of the amplitude of the acceleration Ax and to calculate the displacements UL and US by use of the amplitude of the acceleration Ay.

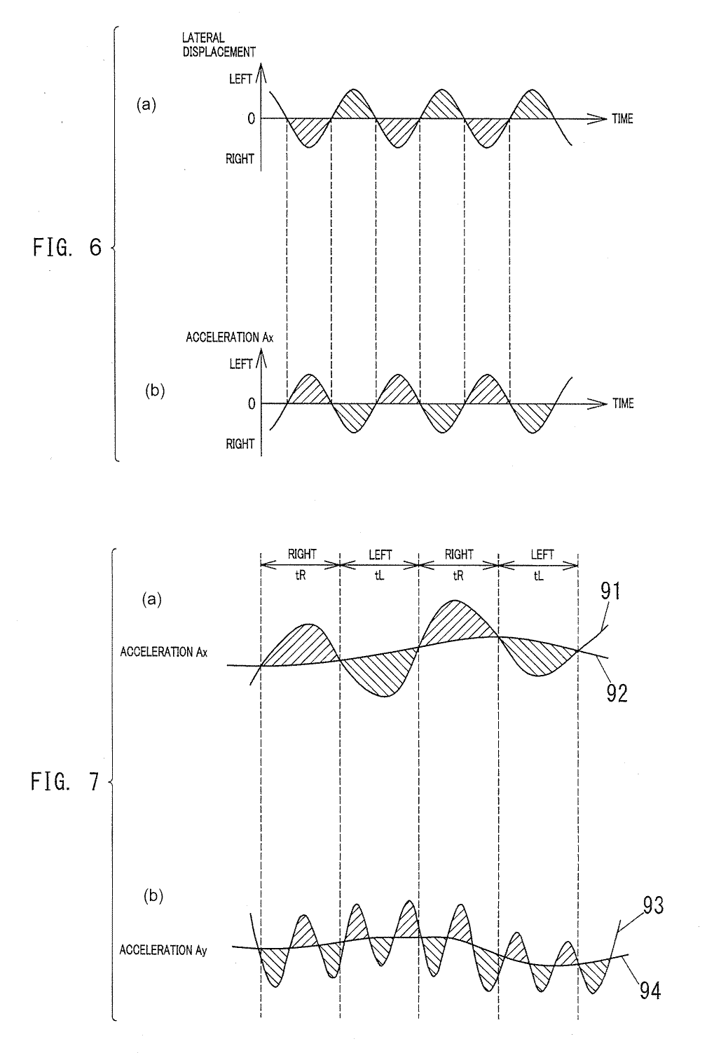

FIG. 6 shows a graph (a) illustrating the displacement in the lateral direction with time. Moreover, FIG. 6 shows a graph (b) illustrating the acceleration Ax with time. A time period in which the displacement in the lateral direction is positive denotes a time period (left side area time period) in which the user 80 performs the passive exercise in the left side area during the one period. A time period in which the displacement in the lateral direction is negative denotes a time period (right side area time period) in which the user 80 performs the passive exercise in the right side area during the one period.

The seat 12 of the horse riding type passive exercise device 10 shows a periodic motion similar to a simple harmonic motion. Therefore, the trace of the acceleration Ax is opposite in phase to the trace of the displacement.

In (b) of FIG. 6, the gravity acceleration is neglected. Actually, the acceleration Ax includes a component (X-axial component) of the gravity acceleration. Therefore, as shown in (a) of FIG. 7, the acceleration Ax shows a trace 91 with varying base line 92.

As mentioned in the above, the seat 12 of the passive exercise device 10 shows a periodic motion similar to a simple harmonic motion. Therefore, the periodic average a(Ax) of the acceleration Ax is assumed to be equivalent to an periodic average of the X-axial component of the gravity acceleration. Consequently, the base line 92 of the acceleration Ax is assumed to be similar to the periodic average a(Ax) of the acceleration Ax. The periodic average at a time t is defined as an average of the acceleration Ax during a time period from a time t−T to a time t+T. Notably, T denotes the period of the seat 12 of the passive exercise device 10.

Consequently, an absolute value of a value obtained by subtracting the periodic average a(Ax) from the acceleration Ax is considered as the amplitude of the acceleration Ax.

The lateral swing (displacements SR and SL) is calculated by time integration of the amplitude of the acceleration Ax. The displacement SR is represented by the following formula (3), wherein tR denotes the right side area time period. Additionally, the displacement SL is represented by the following formula (4), wherein tL denotes the left side area time period.

$$\begin{matrix}[ Formula 3 ] & \\ SR = {\sum }_{tR} \vert Ax - a ( Ax ) \vert \times Δ t & ( 3 ) \\ SL = {\sum }_{tL} \vert Ax - a ( Ax ) \vert \times Δ t & ( 4 )\end{matrix}$$

The right side area time period tR and the left side area time period tL can be calculated from the acceleration Ax. That is, the data analysis function unit 37 selects a time period in which the acceleration Ax exceeds the periodic average a(Ax) as the right side area time period tR, and selects a time period in which the acceleration Ay exceeds the periodic average a(Ay) as the left side area time period tL. Additionally, a time period from a start time of the right side area time period tR to a start time of the next right side area time period tR is considered as a period of a motion of the lower back of the user 80. The period of the motion of the lower back of the user 80 is calculated as mentioned in the above, and is used for calculation of the stability degree.

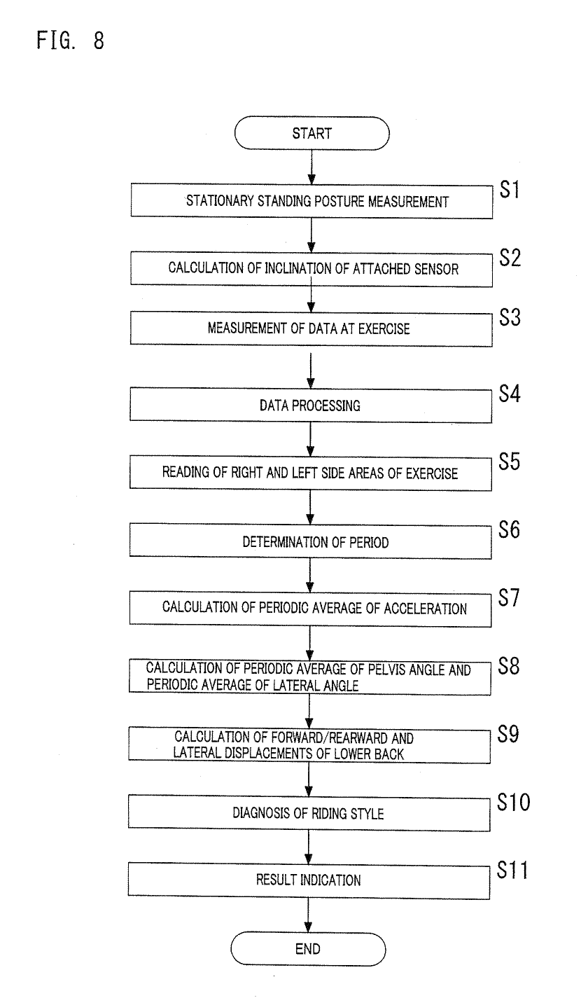

Additionally, the gravity acceleration affects on a trace of the acceleration Ay in a similar manner as the trace of the acceleration Ax. Therefore, as shown in (b) of FIG. 8, the acceleration Ay shows a trace 93 with varying base line 94.

Therefore, also concerning to the acceleration Ay, an absolute value of a value obtained by subtracting the periodic average a(Ay) from the acceleration Ay is considered as the amplitude of the acceleration Ay.

As shown in the following formulae (5) and (6), the forward/rearward swing (displacements UR and UL) is calculated by time integration of the amplitude of the acceleration Ay.

$$\begin{matrix}[ Formula 4 ] & \\ UR = {\sum }_{tR} \vert Ay - a ( Ay ) \vert \times Δ t & ( 5 ) \\ UL = {\sum }_{tL} \vert Ay - a ( Ay ) \vert \times Δ t & ( 6 )\end{matrix}$$

Next, an explanation is made to a calculation method of the right-and-left balance. The data analysis function unit 37 calculates a right-and-left balance of the lateral swing and a right-and-left balance of the forward/rearward swing. For example, the data analysis function unit 37 divides the displacement SL by the displacement SR to obtain the right-and-left balance of the lateral swing. The data analysis function unit 37 divides the displacement UL by the displacement UR to obtain the right-and-left balance of the forward/rearward swing.

Finally, an explanation is made to a calculation method of the stability degree. For example, the data analysis function unit 37 calculates a stability degree of the forward/rearward swing and a stability degree of the lateral swing. In a more detailed example, the data analysis function unit 37 calculates standard deviations of the displacements SL, SR, UL, and UR as stabilities, respectively.

Besides, the data analysis function unit 37 calculates a periodic average θ3 of the pelvis angle θ1 from the periodic average a(Ay) of the acceleration Ay in the forward/rearward direction by use of the following formula (7). In addition, the data analysis function unit 37 calculates a periodic average θ4 of a lateral angle from the periodic average a(Ax) of the acceleration Ax in the lateral direction by use of the following formula (8).

$$\begin{matrix}[ Formula 5 ] & \\ θ 3 = {sin}^{- 1} ( \frac{- a ( Ay )}{g} ) - θ 0 & ( 7 ) \\ θ 4 = {sin}^{- 1} \frac{- a ( Ax )}{g} & ( 8 )\end{matrix}$$

The exercise instruction preparing unit 38 is configured to make evaluations of the posture of the user 80 by comparing the diagnostic indexes (in the present embodiment, the five diagnostic indexes, that is, the forward/rearward swing, the lateral swing, the pelvis angle, the right-and-left balance, and the stability degree) with predetermined reference values, respectively.

For example, the exercise instruction preparing unit 38 decides the right-and-left balance of the lateral swing is good when the right-and-left balance (SL/SR) of the lateral swing is approximately 1. Additionally, the exercise instruction preparing unit 38 decides the right-and-left balance of the forward/rearward swing is good when the right-and-left balance (UL/UR) of the forward/rearward swing is approximately 1. Further, the exercise instruction preparing unit 38 decides the stability degree is allowable when the standard deviations of the displacements SL, SR, UL, and UR fall within corresponding predetermined acceptance reference ranges, respectively. The reference value for individual diagnostic index can be selected adequately with reference to a result of a simulation of ideal usage and/or accelerations indicative of the skilled person's passive exercise.

In order to simplify an explanation, the following shows an instance in which the posture of the user 80 is evaluated with three grades, that is, good (◯), average (Δ), and poor (X), for each of the four diagnostic indexes, that is, the forward/rearward swing, the lateral swing, the stability degree (stability), and the pelvis angle.

The exercise instruction preparing unit 38 is configured to, upon making the evaluation the posture of the user 80, prepare the exercise instruction on the basis of the resultant evaluation.

The exercise instruction storage unit 39 is configured to store exercise instructions corresponding to the evaluation (◯, Δ, and X) for individual diagnostic index. The exercise instruction is defined as an instruction for remediation of the posture of the user 80. For example, the exercise instruction is a text message as shown in Table 3 below.

TABLE 3

| | ◯ | Δ | X |
|---|---|---|---|
| forward/rearward | Your riding | If you keep that way, your | You should tighten your |
| swing | is excellent. | muscles are strengthened, | abdominal muscles firmly. |
| | Keep your | and the forward/rearward | |
| | riding. | swing is expected to be | |
| | | gradually stabilized. | |
| lateral swing | | If you keep that way, your | You should tense your thighs. |
| | | muscles are strengthened, | |
| | | and the lateral swing is | |
| | | expected to be gradually | |
| | | stabilized. | |
| stability degree | | If you keep that way, your | You should keep your head |
| | | muscles are strengthened, | and shoulders stable. |
| | | and the stability degree is | |
| | | expected to be gradually | |
| | | stabilized. | |
| pelvis angle | | If you keep that way, your | (for a user with one's pelvis |
| | | pelvis is loosened, and the | inclined rearward) |
| | | pelvis angle is expected to | You should draw your stomach |
| | | be gradually improved. | and try to orient your anus |
| | | | downward without moving your |
| | | | head and shoulders. |
| | | | (for a user with one's pelvis |
| | | | inclined forward) |
| | | | You should hold yourself erect |
| | | | and imagine your hair whorl is |
| | | | being pulled towards a ceiling |
| | | | without moving your head and |
| | | | shoulders. |

In order to prepare the exercise instruction, the exercise instruction preparing unit 38 reads out the exercise instruction corresponding to the evaluation of the posture of the user 80 from the exercise instruction storage unit 39. For example, when all the evaluations of the four diagnostic indexes are “◯”, the exercise instruction preparing unit 38 prepares the exercise instruction which reads “Your riding is excellent. Keep your riding”. When the evaluation of at least one of the four diagnostic indexes is “Δ” or “X”, the exercise instruction preparing unit 38 reads out the exercise instruction corresponding to the resultant evaluation indicative of “Δ” or “X” from the exercise instruction storage unit 39. When the plural diagnostic indexes evaluated as “Δ” or “X” are present, the exercise instruction preparing unit 38 combines the exercise instructions corresponding to the respective diagnostic indexes. For example, when both of the evaluation for the “lateral swing” and the evaluation for the “stability degree” are “X”, the exercise instruction preparing unit 38 prepares the exercise instruction which reads “You should keep your head and shoulders stable, and tense your thighs firmly”. For example, when both of the evaluation for the “lateral swing” and the evaluation for the “stability” are “Δ”, the exercise instruction preparing unit 38 prepares the exercise instruction which reads “If you keep that way, your muscles are strengthened, and the lateral swing and the stability degree are expected to be gradually stabilized”.

Additionally, the arithmetic processing unit 31 is configured to prepare an indication data. For example, the indication data is defined to allow the image display device 40 to display the exercise trace, a graph showing a variation of the pelvis angle θ1, the evaluations of the respective diagnostic indexes, and the exercise instruction.

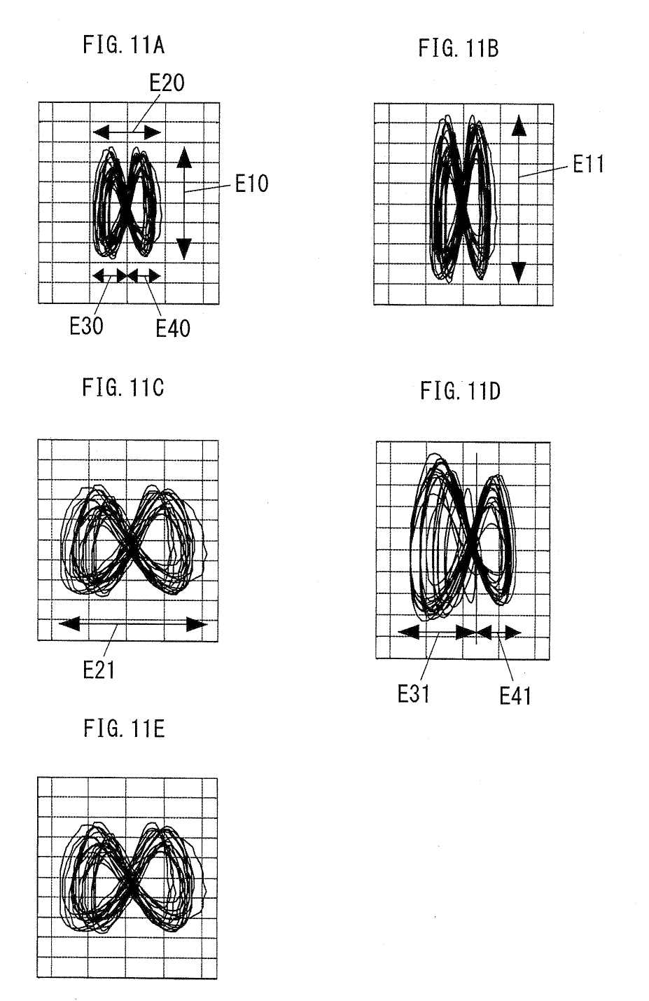

Besides, the arithmetic processing unit 31 modifies a template by use of the displacements SR, SL, UR, and UL as parameters, thereby preparing the exercise trace. The template indicates a reference. For example, the template indicates an ideal exercise trace as shown in FIG. 11A.

The network communication unit 33 transmits the indication data prepared by the arithmetic processing unit 31 to the server 50. In this manner, the exercise instruction prepared by the exercise instruction preparing unit 38 is output to the image display device 40.

Next, a brief explanation is made to an operation of the posture evaluation device 30. When the network communication unit 33 receives below-mentioned first or second execution request signal, the data collection function unit 36 controls the wireless communication unit 32 to transmit the acceleration request signal. The data analysis function unit 37 calculates the diagnostic indexes on the basis of the acceleration A received at the wireless communication unit 32 from the acceleration sensor 20. The exercise instruction preparing unit 38 makes, utilizing the diagnostic indexes calculated by the data analysis function unit 37, the evaluation of the posture of the user 80 who is performing the passive exercise. Additionally, the exercise instruction preparing unit 38 prepares the exercise instruction on the basis of the evaluations for the diagnostic indexes. The network communication unit 33 transmits to the sever 50 the indication data including a data indicative of the exercise instruction prepared by the exercise instruction prepared by the exercise instruction preparing unit 38.

The image display device 40 is configured to indicate to the user 80 the exercise instruction prepared by the exercise instruction preparing unit 38. For example, the image display device 40 is a television device (e.g., a liquid crystal television) having a function of connecting to a network. The image display device 40 is placed in a position such that the user 80 sitting on the seat 12 can see the image display device 40.

The image display device 40 displays on its screen 41 an image distributed from the application 51 of the server 50 via the communication network 70. The image display device 40 includes a wireless reception unit 42 configured to receive a wireless signal (e.g., an infrared signal) sent from a remote controller 60. The remote controller 60 sends the wireless signal in response to manual operation of the user 80.

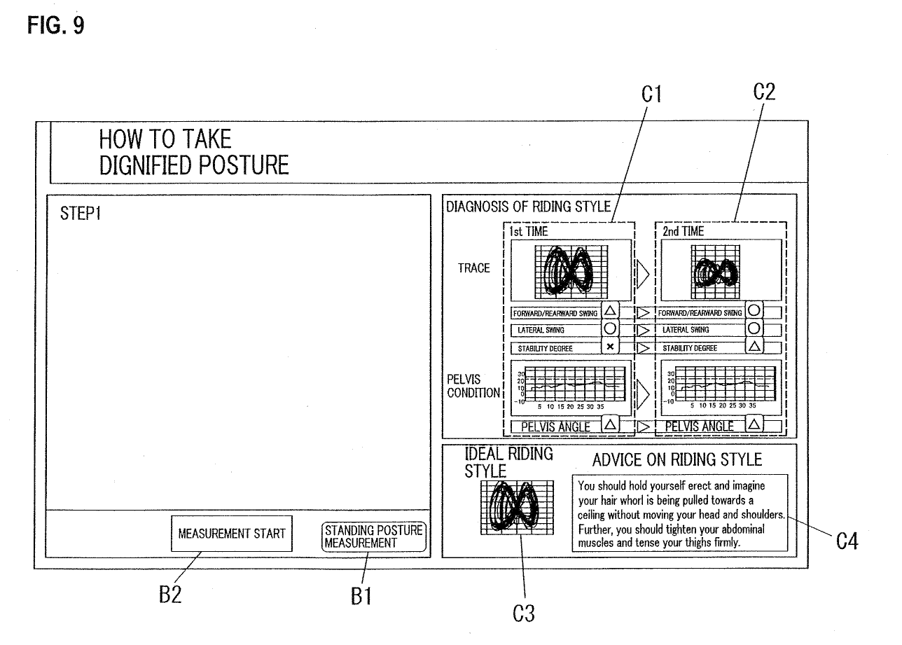

The image display device 40 executes, in accordance with an instruction indicated by the wireless signal received by the wireless reception unit 42, a processing of selecting a channel or volume, a processing of displaying on the screen 41 a web page (see FIG. 9) provided by the server 50, and a processing of controlling the server 50 to execute the application 51.

Next, a brief explanation is made to operation of the exercise system of the present embodiment, with reference to a flow chart shown in FIG. 8.

First, the image display device 40 is controlled, by use of the remote controller 60, to display the web page (see. FIG. 9) for the posture diagnosis.

The web page shown in FIG. 9 displays a standing posture measurement button B1 and a measurement start button B2 in the middle of its lower part.

The standing posture measurement button B1 is provided to allow the posture evaluation device 30 to execute the zero point correction processing. For proper execution of the zero point correction processing, the user 80 is required to attach the acceleration sensor to own lower back and to keep the standing posture.

The measurement start button B2 is provided to allow the posture evaluation device 30 to execute the posture diagnosis processing. For proper execution of the posture diagnosis processing, the user 80 is required to attach the acceleration sensor to own lower back and to perform the passive exercise with the passive exercise device 10.

When the standing posture measurement button B1 is selected by use of the remote controller 60, the image display device 40 sends a signal (first notification signal), which indicates selection of the standing posture measurement button B1, to the server 50.

Upon receiving the first notification signal, the server 50 executes the application 51.

The server 50 transmits a signal (first execution request signal) indicative of a request for execution of the zero point correction processing to the posture evaluation device 30 in accordance with an instruction of the application 51.

When the network communication unit 33 of the posture evaluation device 30 receives the first execution request signal, the data collection function unit 36 and the wireless communication unit 32 cooperates with each other to acquire the acceleration A from the acceleration sensor 20 over the predetermined measurement time period and thereafter store the acquired acceleration A in the collected data storage unit 34 (step S1).

Thereafter, the data analysis function unit 37 obtains the acceleration Ax stored in the collected data storage unit 34, and subsequently calculates the offset angle θ0 (step S2).

Subsequently, when the measurement start button B2 is selected by use of the remote controller 60, the image display device 40 sends a signal (second notification signal), which indicates selection of the measurement start button B2, to the server 50.

Upon receiving the second notification signal, the server 50 executes the application 51. The server 50 transmits a signal (second execution request signal) indicative of a request for execution of the posture diagnosis processing to the posture evaluation device 30 in accordance with an instruction of the application 51.

When the network communication unit 33 of the posture evaluation device 30 receives the second execution request signal, the data collection function unit 36 and the wireless communication unit 32 cooperates with each other to acquire the acceleration A from the acceleration sensor 20 over the predetermined measurement time period and thereafter store the acquired acceleration A in the collected data storage unit 34 (step S3).

Thereafter, the data analysis function unit 37 obtains the acceleration A of the acceleration sensor 20 from the collected data storage unit 34. The data analysis function unit 37 corrects the inclination of the acceleration sensor 20 by use of the offset angle θ0 (step S4).

Subsequently, the data analysis function unit 37 determines the right side area time period tR and the left side area time period tL on the basis of the X-axial acceleration Ax in the lateral direction (step S5).

Then, the data analysis function unit 37 determines the period on the basis of a determination at the step S5 (step S6).

Thereafter, the data analysis function unit 37 calculates the periodic average a(Ax) of the acceleration Ax and the periodic average a(Ay) of the acceleration Ay (step S7).

Subsequently, the data analysis function unit 37 calculates the periodic average θ3 of the pelvis angle θ1 and the periodic average θ4 of the lateral angle by use of the above formulae (7) and (8), respectively (step S8).

After that, the data analysis function unit 37 calculates the forward/rearward swing and the lateral swing by use of the above formulae (3) to (6) (step S9). Additionally, the data analysis function unit 37 calculates the right-and-left balance and the stability degree.

Then, the exercise instruction preparing unit 38 makes evaluations of the posture of the user 80 by comparing the diagnostic indexes calculated by the data analysis function unit 37 with predetermined reference values, respectively. Further, the exercise instruction preparing unit 38 prepares the exercise instruction on the basis of the resultant evaluation of the posture of the user 80 (step S10). The posture evaluation device 30 prepares the indication data and sends the same to the server 50.

The application 51 controls, on the basis of the indication data received at the server 50, the image display device 40 to indicate the web page displaying the exercise trace, the graph illustrating the variation of the pelvis angle θ1, and the exercise instruction together with the evaluations for each diagnostic indexes (step S11).

The web page illustrated in FIG. 9 shows the previous diagnosis C1 and the current diagnosis C2 side-by-side on a right upper part of the page. Each of the diagnosis C1 and C2 shows the diagnoses (◯, Δ, and X) for each evaluation point, the exercise trace, and the graph illustrating the variation of the pelvis angle θ1. Additionally, the web page illustrated in FIG. 9 shows the exercise instruction C4, in addition to a trace C3 of the lower back realized when the user rides in an ideal manner on a right lower part of the page. Beside, the diagnosis regarding the right-and-left balance is not shown in the instance illustrated in FIG. 9. However, the diagnosis regarding the right-and-left balance may be shown.

As described in the above, the exercise system of the present embodiment can indicate the exercise instruction for remediation of the posture of the user 80 during the passive exercise to the user 80. Therefore, the user 80 can remedy own posture at the passive exercise in accordance with the indicated exercise instruction. As a result, the user 80 can perform an effective training without an exercise instructor.

Additionally, the posture evaluation device 30 includes the exercise instruction storage unit 39 configured to store the exercise instructions When preparing the exercise instruction, the exercise instruction preparing unit 38 is configured to read out the exercise instruction corresponding to the resultant evaluation of the posture of the user 80 from the exercise instruction storage unit 39. Therefore, the exercise system can easily prepare the exercise instruction.

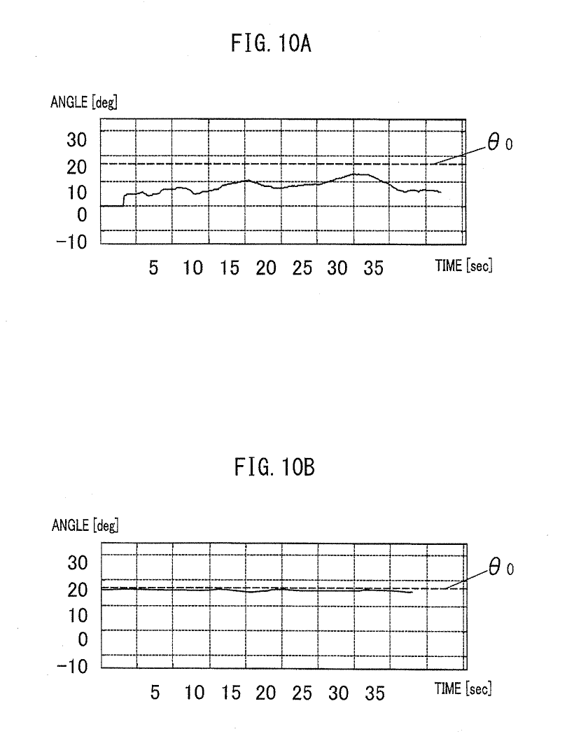

FIG. 10 shows the pelvis angle θ1 varying with time during the passive exercise. In FIG. 10A, the pelvis angle θ1 is smaller than the pelvis angle (offset angle) θ0 at the standing posture. That is, the pelvis tends to be inclined rearward and becomes unstable. In this situation, the exercise system prepares the exercise instruction reading “You should draw your stomach and try to orient your anus downward without moving your head and shoulders”, and indicates the same to the user 80 through the image display device 40, for example.

Therefore, the user 80 can remedy own standing posture through practicing the passive exercise in accordance with the exercise instruction indicated by the image display device 40. As a result, as shown in FIG. 10B, the pelvis angle θ1 at the passive exercise becomes stabilized near the pelvis angle θ0 at the standing posture.

FIGS. 11A to 11E illustrate exercise traces (movement traces).

FIG. 11A shows an ideal exercise trace. In the instance shown in FIG. 11A, the lateral swing E30 of the left side area is close to the lateral swing E40 of the right side area.

In the instance shown in FIG. 11B, the forward/rearward swing E11 is greater than the forward/rearward swing E10 of FIG. 11A. In this situation, the exercise system indicates the exercise instruction reading “You should tighten your abdominal muscles firmly” to the user 80 through the image display device 40, for example.

Therefore, the user 80 can remedy one's standing posture through practicing the passive exercise in accordance with the exercise instruction indicated on the image display device 40. Consequently, as shown in FIG. 11A, the user 80 can have the forward/rearward swing E11 close to the ideal forward/rearward swing E10 during the passive exercise.

In the instance shown in FIG. 11C, the lateral swing E21 is greater than the lateral swing E20 of FIG. 11A. In this situation, the exercise system indicates the exercise instruction reading “You should tense your thighs” to the user 80 through the image display device 40, for example.

Therefore, the user 80 can remedy own standing posture through practicing the passive exercise in accordance with the exercise instruction indicated by the image display device 40. Consequently, as shown in FIG. 11A, the user 80 can have the lateral E21 close to the ideal lateral swing E20 during the passive exercise.

In the instance shown in FIG. 11D, the lateral displacement E31 of the left side area is greater than the lateral displacement E41 of the right side area, and the right-left balance is poor. In this situation, the exercise system indicates the exercise instruction reading “Your motion is offset leftward. You should sit on the center of the seat, and try to exercise in a bilaterally symmetrical manner” to the user 80 through the image display device 40, for example.

Therefore, the user 80 can remedy own standing posture through practicing the passive exercise in accordance with the exercise instruction indicated by the image display device 40. Consequently, the user 80 can improve the right-left balance during the passive exercise.

In the instance shown in FIG. 11E, the dispersion of the forward/rearward swing per unit period and the dispersion of the lateral swing per unit period are greater than those of the instance shown in FIG. 11A (the stability degree is poor). In this situation, the exercise system indicates the exercise instruction reading “You should try not to move your head and shoulders” to the user 80 through the image display device 40, for example.

Therefore, the user 80 can remedy own standing posture through practicing the passive exercise in accordance with the exercise instruction indicated by the image display device 40. Consequently, the user 80 can improve the stability degree during the passive exercise.

Additionally, the posture evaluation device 30 adopts the variation (pelvis angle) of the angle of pelvis of the user 80 relative to the vertical direction as the diagnostic index. Therefore, the exercise system can evaluate whether or not the user can keep the pelvis in a proper position with an aid of one's abdominal or back muscles.

Further, the posture evaluation device 30 adopts the forward/rearward displacement (forward/rearward displacement of the lower back) of the body of the user 80 as the diagnostic index. Therefore, the exercise system can evaluate whether or not the user can absorb the movement of the seat 12 in the forward/rearward direction by the effect of varying the angle of the pelvis. The exercise system can also evaluate whether or not the user can support the pelvis by tensing one's abdominal muscles. Further, the exercise system can evaluate whether or not the user's upper body does not move in the forward/rearward direction.

Moreover, the posture evaluation device 30 adopts the lateral displacement (lateral displacement of the lower back) of the body of the user 80 as the diagnostic index. Therefore, the exercise system can evaluate whether or not the user supports one's own lower back by holding the seat 12 between one's tensed thighs. The exercise system can evaluate whether or not the user's upper body does not move in the lateral direction.

In addition, the posture evaluation device 30 adopts, as the diagnostic index, the difference (bilateral difference of individual diagnostic index) between the movement of the body of the user 80 obtained while the seat 12 is inclined leftward and the movement of the body of the user 80 obtained while the seat 12 is inclined rightward. Therefore, the exercise system can evaluate whether or not the user is making laterally balanced exercise.

In addition, the posture evaluation device 30 adopts, as the diagnostic index, the dispersion (bilateral difference of individual diagnostic index) of the other diagnostic index. Therefore, the exercise system can evaluate whether or not the user is making the passive exercise in a stably manner. Beside, the diagnostic index may be defined as a dispersion of a value per unit period. The value is calculated by use of the acceleration obtained from the acceleration sensor 20. Also in this situation, the exercise system can evaluate whether or not the user is making the passive exercise in the stably manner.

Besides, in the exercise system of the present embodiment, the computer (posture evaluation device 30) configured to collect the acceleration A of the acceleration sensor 20 has a function of calculating the respective diagnostic indexes, and a function of diagnosing the posture on the basis of the respective diagnostic indexes. However, the server 50 may have the function of calculating the respective diagnostic indexes and the function of diagnosing the posture on the basis of the respective diagnostic indexes.

1. An exercise system comprising a passive exercise device, an acceleration sensor, a posture evaluation device, and an indication device,
wherein said passive exercise device includes a seat where a user sits, and is configured to move said seat to allow the user to perform a passive exercise,
said acceleration sensor being adapted to be attached around the user's lower back, and being configured to measure accelerations respectively in three axial directions and output the measured accelerations to said posture evaluation device,
said posture evaluation device including a physical amount calculation unit and an exercise instruction preparing unit,
said physical amount calculation unit being configured to calculate, on the basis of the acceleration output from said acceleration sensor, a physical amount for evaluation of a posture of the user performing the passive exercise,
said exercise instruction preparing unit being configured to make an evaluation of the user's posture by comparing the physical amount calculated by said physical amount calculation unit with a predetermined reference value, and prepare, on the basis of the resultant evaluation, an exercise instruction for remediation of the user's posture, and
said indication device being configured to indicate the exercise instruction prepared by said exercise instruction preparing unit to the user.

2. An exercise system as set forth in claim 1, wherein
said posture evaluation device includes an exercise instruction storage unit configured to store said exercise instructions,
said exercise instruction preparing unit being configured to read out the exercise instruction corresponding to the resultant evaluation of the user's posture from said exercise instruction storage unit, thereby preparing the exercise instruction.

3. An exercise system as set forth in claim 1, wherein
said passive exercise device is configured to reciprocate said seat along a forward/rearward direction within a plane perpendicular to a lateral direction,
said physical amount being defined as a variation of an angle of the user's pelvis relative to a vertical direction.

4. An exercise system as set forth in claim 1, wherein
said passive exercise device is configured to reciprocate said seat along a forward/rearward direction within a plane perpendicular to a lateral direction,
said physical amount being defined as a forward/rearward displacement of the user's body.

5. An exercise system as set forth in claim 1, wherein
said passive exercise device is configured to reciprocate said seat along a lateral direction within a plane perpendicular to a forward/rearward direction,
said physical amount being defined as a lateral displacement of the user's body.

6. An exercise system as set forth in claim 1, wherein
said passive exercise device is configured to reciprocate said seat in a bilaterally symmetrical manner,
said physical amount being defined as a difference between a movement of the user's body obtained while said seat is inclined leftward and a movement of the user's body obtained while said seat is inclined rightward.

7. An exercise system as set forth in claim 1, wherein
said passive exercise device is configured to move said seat periodically,
said physical amount calculation unit being configured to calculate a plurality of the physical amounts, and
one of the plurality of the physical amounts being defined as a dispersion of another physical amount per unit period.

8. An exercise system as set forth in claim 1, wherein
said passive exercise device is configured to move said seat periodically,
said physical amount being defined as a dispersion of a value per unit period, and said value being calculated by use of the acceleration obtained from said acceleration sensor.
